(19) United States
(12) Patent Application Publication
(10) Pub. No.: US 2011/0311007 A1
(43) Pub. Date: Dec. 22, 2011

(54) Method and an Apparatus for Forming Signal Estimates

(75) Inventors: Jukka-Pekka Nuutinen, Martinniemi (FI); Marko Pyy, Pattijoki (FI); Marko Tapaninaho, Kempele (FI)

(73) Assignee: ELEKTROBIT SYSTEM TEST OY, Oulu (FI)

(21) Appl. No.: 13/148,722

(22) PCT Filed: Feb. 16, 2009
(86) PCT No.: PCT/FI09/50120

§ 371 Date: Aug. 10, 2011

(51) Int. Cl. H04B 1/10

(52) U.S. Cl. 375/350

(57) ABSTRACT

The invention relates to a method and a device for extracting the signal components and/or the interference components. In the invention a channel measurement signal is received, the signal is filtered, the filtered signal is reconstructed, the reconstructed signal is subtracted from the channel measurement signal for obtaining a residual signal (r-s); and the residual signal is fed back to be combined with the channel measurement signal.

### CROSS-REFERENCE TO RELATED APPLICATION

This application is a National Phase application of International Application No. PCT/FI2009/050120, filed Feb. 16, 2009, which is incorporated by reference herein in its entirety.

### BACKGROUND

1. Field

The present invention relates to communications technology, and more particularly to processes for iteratively forming signal and interference estimates from received data samples.

2. Description of the Related Art

In a communications channel, there exist different disturbances like interference. Because interference reduces the quality of the channel and a communication, methods for reducing the interference have been developed. In order to be able to reduce the interference, characteristics of the communication channel and the interference must be known.

A conventional way to simulate the interference is to formulate the interference by a synthetic interference source. In it dummy data is created, which is then modulated and added to the signal. This data is not based on any measurements or real situations detected in a field environment, but rather to statistical or theoretical considerations. Thus there exist many problems associated with the conventional arrangements. One of such problems is that the conventional way to simulate the interference requires lots of resources, specially hardware resources, and computing resources, such as FPGA (field programmable gate array) resources. This fact leads to complex, slow and inaccurate emulators of the interference and thus low quality of communications.

The document US 2003/0174794 A1 describes reduced-complexity multipath interference cancellation. In the document the interference duplication is performed in a truncated manner, based on a determination of which multipath signals are present, so as to reduce the complexity and processing requirement of the interference duplication. Multipath interference in a received wireless signal is then cancelled by generating the estimated duplicate of the interference and subtracting it from the received signal.

The document EP 1 753 151 A2 describes a mobile communication terminal wherein a reduction is made in computational complexity for cancellation of multipath interference. The terminal equipped with a multipath interference canceller includes a number-of-samples controlling means, channel matrix generating means, and interference cancelling means for cancelling multipath interference on the basis of the channel matrix generated by the channel matrix generating means.

### SUMMARY

An object of the present invention is thus to provide a method and an apparatus for implementing the method so as to overcome the above problems. The objects of the invention are achieved by a method and an arrangement, which are characterized by what is stated in the independent claims. The preferred embodiments of the invention are disclosed in the dependent claims.

The invention is based on the idea of using a measured interference as a signal. Because in cellular and equivalent networks the most severe interference sources can be known a priori, the matched filters can specially be designed for said sources. The output of the matched filter is an impulse response.

There exist many advantages of the invention and its embodiments. E.g. the interference profile is now based on the measurements and not on the guess such as in prior art synthetic cases, enabling the full realism. Furthermore, the complexity of a test setup becomes less critical than in direct playback modes. An advantage of the method and arrangement of the invention is simpler structure and faster functioning of the emulator. Less hardware resources is needed than in conventional solutions.

### BRIEF DESCRIPTION OF THE DRAWINGS

In the following the invention will be described in greater detail by means of preferred embodiments with reference to the attached drawings, in which

FIG. 1 is a block diagram of the invention and its embodiments;

FIG. 2 is a graph of an incoming signal detected impulse response versus excess delay;

FIG. 3 is a graph of the incoming signal detected impulse response versus excess delay;

FIG. 4 is a block diagram of the invention and its embodiments;

FIG. 5 is a graph of impulse response versus excess delay of an interfering signal; and

FIG. 6 is a block diagram of the invention and its embodiments.

### DETAILED DESCRIPTION

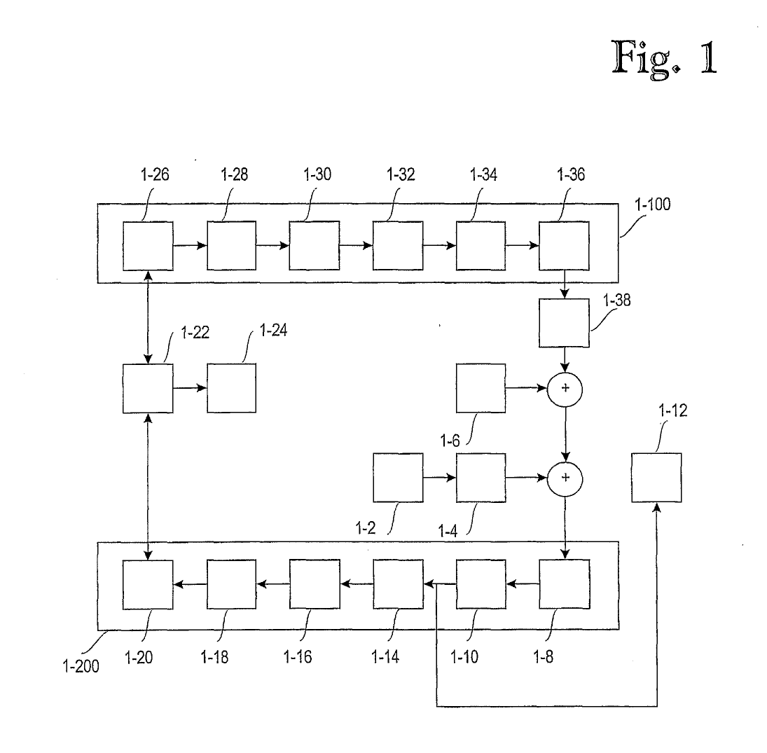

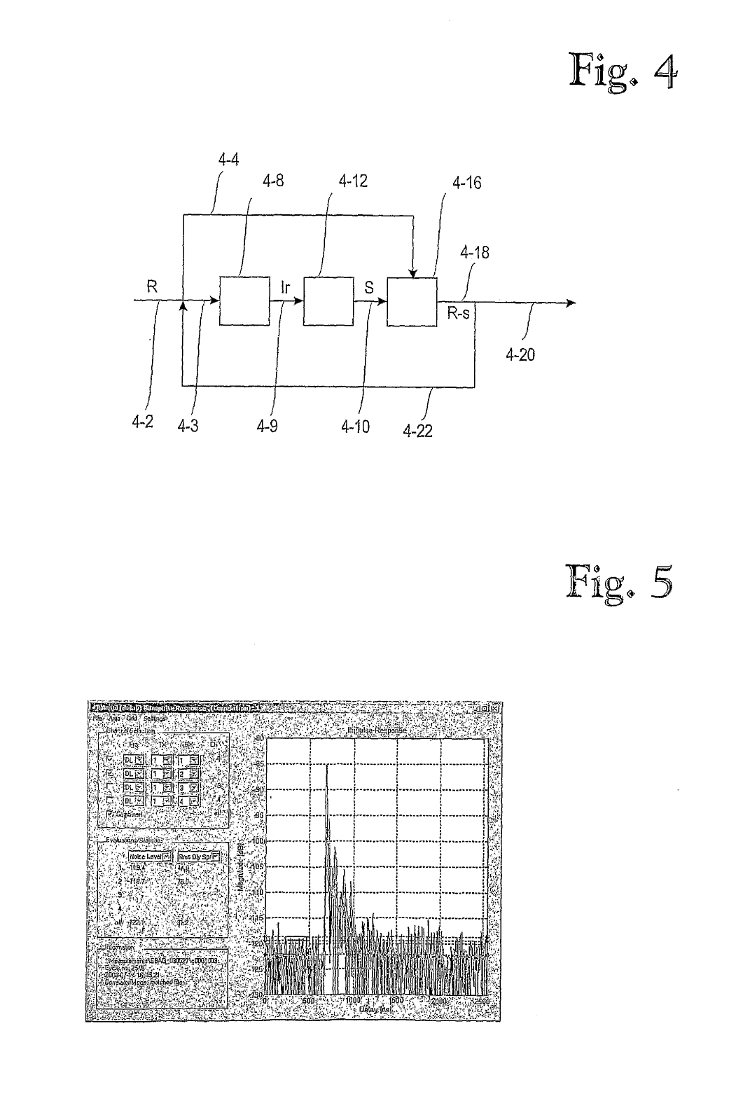

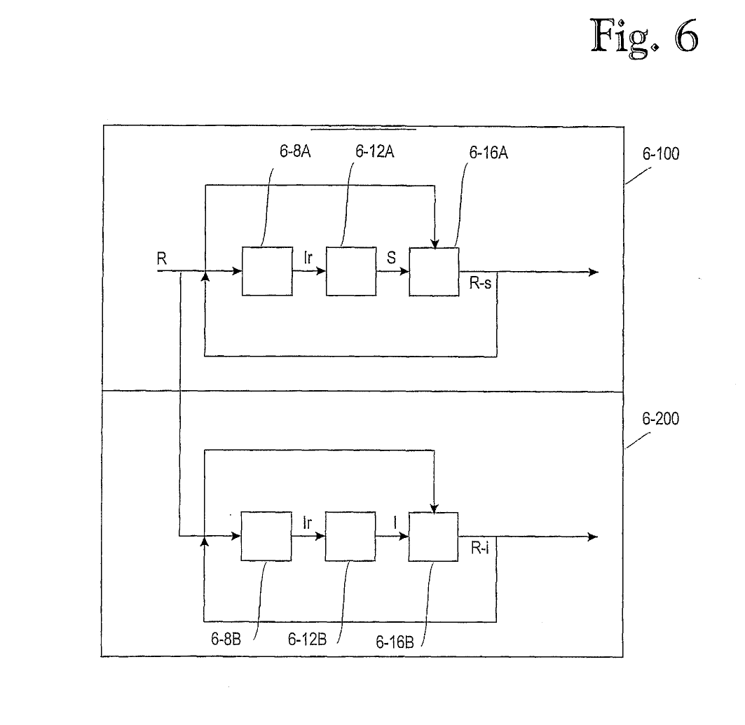

FIG. 1 is a block diagram of the invention and its embodiments. In FIG. 1 two different lines 1-100, 1-200 can be found: the first one (a receiver end) 1-200 of the elements 1-8, 1-10 and 1-14 to 1-20 and of the second one (a transmitter end) 1-100 of the elements 1-26 to 1-36. Between these two lines some other elements can be found: the elements 1-2 to 1-6, 1-12, 1-22 to 1-24, and 1-38. The interference for the radio channel or the interference that is thought to be on the channel can be generated in an interference generation unit 1-2 e.g. for adding the interference on the channel. The interference can be e.g. noise, impulses, imitation of other signals, and/or other interference, and the interference can be generated e.g. by hardware or the interference can be retrieved from a database or a memory, from stored data. This means that when the signal is captured from the air, the captured data contains signal and the interference. Now this interference is estimated by subtracting the signal from the total received data. This residual signal can then be played back. The signal and/or the noise or interference is modeled to a realistic model for doing play back, which model may then be emulated. This can be done in this phase or in the phase 1-12 (see e.g. FIGS. 4 and 6 above). This model can be fed to a radio channel unit 1-4. Also noise can be generated and added to the radio channel. For this purpose a noise source 1-6 generates noise. Noise and interference are then added to the radio channel 1-38, after which the radio channel data is forwarded to a cyclic prefix removal element 1-8. This element removes cyclic prefix meaning that during the cyclic prefix the channel is typically estimated. Also, if the delay spread is larger than the cyclic prefix CP, the inter symbol interference ISI is caused. This is important, because above mentioned reasons. The signal forwards to an FFT element 1-10, in which element a discrete Fourier transform is processed to the signal fast and in an efficient way. The transform can be in a form of a fast Fourier transform FFT. After the FFT element an intermediary output can take the signal to a radio channel and interference estimator element 1-12 for estimating or emulating the signal and the interference.

Instead of or in addition to a hard demodulation, the signal can proceed to a soft demodulation block 1-14 after the FFT block for demodulating purposes. In this block a probability value of a codeword of a signal can be calculated and an analog value for the signal can be outputted. Thus e.g. for the signal level 1, a probability value 0.7 or 0.75 or 0.8 or some other value can be obtained and for the signal level −1, a probability value −0.7 or −0.75 or −0.8 can be obtained.

Then, a decoder 1-16, such as a Viterbi decoder, receives the probability of a dataword of the signal from the soft demodulator and decodes the codeword of the signal into the dataword of the signal. The decoder can be e.g. a soft decoder or a turbo decoder. After decoding process a bit estimator 1-18 estimates the values for different bits of the dataword of the signal. The values can be 0, 1; 0, +1, −1; or +1, −1; or some other values. The estimation can be based on e.g. a maximum likelihood method by integrating a received or indicated voltage to the threshold level or from the threshold level.

When the certain voltage, current or other signal level(s) is (are) estimated for the bits, a bit decision block 1-20 can decide what value the bit obtains. The decision(s) can be made partially or completely, and decisions can be soft or hard. Different tables or matrixes can be used for the decisionmaking process.

Bits from a bit source or a bit source element, from a bit generation or from a bit detection element 1-26 (in the second line 1-100) and from the bit decision element 1-20 (In the first line 1-200) can be compared in a comparafor 1-22 for different purposes comprising for communications transmission and/or reception quality purposes. The result(s) of the comparison(s) can be fed to a bit error rate BER counter 1-24 for detecting the number of bit errors and the total number of bits and the ratio thereof. The transmission and reception can be calculated or adapted to a given time interval. The thus obtained value indicates whether there are any bits that are transmitted incorrectly and if yes, how many. The type and length of the transmission or reception can also be taken into account.

From the bit source element 1-26 the signal or part of it can be forwarded to a segmentation element 1-28, to a convolutional encoding element 1-30 and to a modulation element 1-32. In these elements the signal is segmented, collected into one or more segments, encoded and finally modulated by varying at least one of the characteristics of the signal. After these elements a Fourier transform can be processed 1-34 for the signal. The transform can be e.g. in a form of an inverse discrete fast Fourier transform IFFT. A cyclic prefix insertion block 1-36 is used for adding some bits to the data block of the signal and for mitigating the effects of interference, like an intersymbolinterference ISI. After all these elements of the line two, the signal can be fed to the radio channel for possibly inserting noise and interference to the signal, as described above.

It must be noted the some or all of the above-mentioned blocks and elements can be divided into two or more elements and some or all of the elements can also be grouped together or grouped alternatively. Also the number of different lines can be more than two. Alternatively, the whole process can be thought to function as a single line.

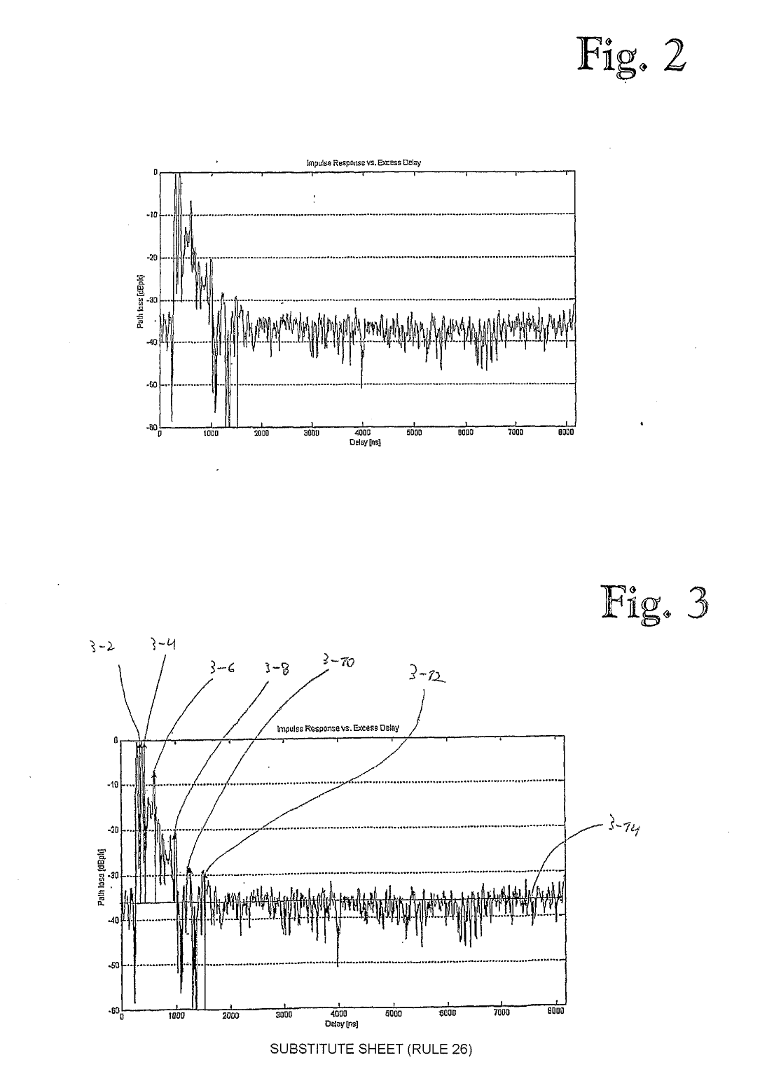

FIG. 2 shows as an output of a matched filter the incoming detected impulse response being a graph of impulse response versus excess delay. The delay can be e.g. thousands of nanoseconds, like 1000 ns, 2000 ns, 3000 ns or 4000 ns and the path loss mainly between −30 to −40 dBpk (pk=peak). As can be seen, there can exist several strong peaks, signal components, which are available in detection. Therefore a SIC cancellation method, Serial Interference Cancellation, can be applied for detecting the incoming signal. The signal can be in a form of

$$s ( t , τ ) = {\sum }_{i = 1}^{N} {A}_{i} {e}^{j 2 π υ t} u ( t - τ ) \qquad ( 1 )$$

where A refers to the amplitude of the signal, the exponent of the equation to the phase of the signal and u to the transmitted signal form. The parameters (A, tau, nu) can be taken from the measured data. In it the strongest peak of impulse response is measured and/or detected and the signal can be reconstructed according the equation (1). This reconstructed signal can then be subtracted from the total signal, giving the residual signal. This residual signal can then be forwarded through one or more matched filters to achieve the new impulse response, from which the second signal component can be estimated by equation (1). This result can then again be subtracted from the first residual signal and so on. Thus with this method the whole incoming signal can be reconstructed with appropriate signal components. This is needed in order to emulate the signal environment, i.e. the radio channel model.

FIG. 3 is a graph of the incoming signal. The above-mentioned SIC principle can also be applied with respect to this Figure. Said Figure shows some impulse response peaks 3-2 to 3-12 and a calibrated path loss scale 3-14 (x-axis) of about −37 dBpk (decibel peak) of the impulse response.

The principle of the SIC method is shown in more detailed in FIG. 4. The input signal 4-2 from a receiver front end is fed to the matched filter 4-8 for filtering out unwanted signal components or some specific frequency range or unwanted interference or some specific interference range and for passing the wanted signal and/or the wanted interference range. The output of the matched filter 4-9 is fed to the signal regeneration, reconstruction element 4-12 for regenerating, reconstructing the signal e.g. according the equation (1). The output 4-10 of the reconstructed signal is then fed to a subtraction element 4-16 to be subtracted from the signal 4-4 fed directly from the input of the SIC element to the subtraction element. Thus the residual signal 4-18 is the output from the subtraction element. In other words, the input signal “r” is subtracted from the regenerated signal “s” given the output signal as “r-s”. This residual signal can then be fed back to the matched filter and forwarded through one or more matched filters to achieve new impulse response(s), from which the second signal component, the third, the fourth etc. signal component(s) can be estimated e.g. by equation (1).

The arrangement and method of the invention and its embodiments shown and described in FIG. 4 can also be applied to the interference estimation. In it, the test receiver is sampling the two or more samples of the signal, like I and Q (In-phase and Quadrature signal) samples. The received signal is driven through the interference matched filter to obtain another impulse response. Basically the exactly same methodology as described above also applies to the interference estimation. After the matched filtering, impulse response of the interference is obtained. It must be noted that in FIG. 4 the signal component is taken out one by one. This means that in the equation 1 there exists a sum over n paths. Then it is possible to reconstruct every path one by one, and also its corresponding signal component, and also thus subtract them one by one from the total received signal.

In other words, a signal is received from a transmitter or retrieved from a database or a memory. The signal can then be fed to a matched filter, which outputs an impulse response. This response or part of it can be matched to the equation 1 or a corresponding equation. A component from a reconstructed signal can thus be established and obtained. A residual signal is obtained from the total signal from which the reconstructed signal component is subtracted. If more signal components are needed, the thus obtained residual signal can further be fed to one or more matched filters, as described above, to achieve the new impulse response(s), from which the second, the third the fourth etc. signal component(s) can be estimated by equation (1).

Instead of the signal, also the interference or both of them can be obtained, as will be described in the following.

FIG. 5 is a graph of impulse response versus excess delay with some settings shown on the left hand side. SIC principle can also be applied to the interfering signal, and the interfering signal can be approximated by

$$i ( t , τ ) = {\sum }_{i = 1}^{N} {A}_{i}^{′} {e}^{j 2 π {υ}^{′} t} {u}^{′} ( t - {τ}^{′} ) \qquad ( 2 )$$

where A′ refers to the amplitude of the interference signal, the exponent exp′ to the phase of the interference signal and u′ to the form of the transmitted interference signal. The parameters (A, tau, nu) can be taken from the measured interference data. In it the strongest peak is measured and/or detected and the signal can be reconstructed according the equation (1).

The above examples are only two examples of the equations. The basic idea is that complex samples may and can be modeled.

Both the signal and the interference SIC may be performed at least partly in parallel or in cascade to the signal estimation. The iterative process can be processed as described previously. The structure of the parallel SIC can be seen in FIG. 6.

FIG. 6 is a block diagram of the invention and its embodiments showing the structure of one parallel SIC structure. The Figure shows two parallel paths, but it can comprise two or more SIC elements 6-100, 6-200 of FIG. 5 with the matched filters 6-8A, 6-8B, the signal regeneration units 6-12A, 6-12B and the subtraction elements 6-16A, 6-16B. The incoming signal “r” is fed to the input of the matched filters, their outputs “ir” are fed to the signal regeneration unit 6-12A and to the interference regeneration unit 6-12B correspondingly and the outputs “s” and “i” respectively are fed to the subtraction elements. Feedback signals “r-s” and “r-i” from the subtraction elements can be fed back to the matched filters. The idea of this structure is to have separate impulse response representations for the signal and the interference of the signal. Thus it is possible to use separate channels or the same channel to emulate radio environment or different radio environments. In addition to simpleness, this structure is efficient because it saves the burden to emulate interference in play backing the residual signal. In other words, a similar or almost a similar model for the interference is established and/or used, which interference is from a signal e.g. from a neighborhood system or a neighborhood cell as it is now possible to formulate the radio channel characteristics out from that this can be as shown in the equation 2 or some other equation describing the interference and thus an impulse response corresponding to the interference can be established, and the impulse response can be emulated like the signal is emulated.

The interference may be in different frequency range than the signal or two or more different frequency range interference signals can be simulated, if necessary, as it is possible to have two or more separate matched filters where each filter can have its own operational frequency or frequency range. The selection of the signal form is usually decided by the frequency allocation. In other words, the interferences may be two adjacent systems in frequency. Typically frequencies can be reused in network architecture, and different cells can use different frequencies. The interference can also be in a different frequency. The equation 2, which describes the interference, is in this example in another frequency than the signal. It is also possibly to have several matched filters in parallel to obtain the filter bank. Thus different combinations of parallel and serial filters, regeneration units, subtraction units and SIC elements are possible and in each case the implementation can be tailored for the specific application.

With the invention and its embodiments several separate emulation files for HW (hardware) emulation can be generated, which files may be emulated separately or they may be combined into one single emulation file.

The invention and its embodiments describe the method and the algorithm to extract the signal and interference, the signal components and the interference components, from the signal and channel measurements and formulation of the corresponding emulation method. In other words, they describe the method and the algorithm how to iteratively form the signal and interference estimates from the received data samples. The interference space and signal space can now be separated. The intention is to sample I and Q samples into the hard disk from which they are processed by software SW and to emulate and play back the network level measurement data. The idea is that the signal is detected from the impulse response one by one, a component by a component, like in the SIC algorithm. In one example, the signal is obtained from the equation 1 and the interference is obtained from the equation 2.

From the residual signal a signal model can be formed for the interference. In this second process an impulse response is formed for the first interference component, which is then regenerated and subtracted and again filtered, reconstructed and subtracted. This can be continued until the energy of the signal and/or the interference is end or below a predetermined level or until only noise can be found or until a triggering event or a condition. A first process can be for the signal and the second process can be for the interference or vice versa. Alternatively, these processes can be simultaneous. In yet another alternative the signal or the interference with two different frequencies, phases, polarization etc. can be formed.

In the invention and its embodiments first the signal is tried to find out. E.g. when the WiMax network or WiMax communication or a communication, which comprises WiMax communication or a mixed communication which also comprises WiMax communication is measured, the WiMax signal is first tried to found out. This is because the WiMax signal is known. The matched filtering is done for this type of signal or communication and what is left may be interpreted as interference, which may then be further examiner or detected.

If the communication also comprises some other specific type or known communication or communication, which is known a priori that type of communication can also be tried to find out either before WiMax communication or after it. In other words, the total communication can comprise a first type of communication and a second type of communication, which may be detected simultaneously or in parallel and only after that the interference may be detected.

The signal and the interference may also be interleaved e.g. such that the first component is the (e.g. the first) WiMax component, the second component is the (e.g. the first) interference component, then comes the second WiMax component, the second interference component, the third WiMax component, the fourth WiMax component, the third interference component etc.

It is to be noted that WiMax communication is to be interpreted as an example and not the only type of communication.

When processing the whole communication, first the total communication comprising the signal and the interference can be stored in a memory or a database and then the (known) signal can be detected or obtained and after that the interference can be detected or obtained. The total communication or part of it or the signal or the interference can be stored and retrieved e.g. for the measurement, calculation, detection and process purposes in one or more phases. In one embodiment first the total communication is stored and then the signal is stored, when it is found out.

The estimate of the interference is processed in the receiver. It may be processed e.g. after the FFT blocks. The IFFT of the frequency is an impulse response. Thus its impulse response e.g. in OFDM system has to be calculated in some phase, but latest in synchronization.

In the invention and its embodiments a system for creating dummy data, modulating said data and inserting said data to a communications signal is also provided. The interference is thus used as the signal. Because in cellular and equivalent networks the most severe interference sources can be known a priori, the matched filters can specially be designed for them. The output of the matched filter is an impulse response.

If the interference sources cannot be known a priori filter banks may be used to estimate the interference (e.g. as a blind estimation) or a general estimate of a noise rise can be processed or done and/or the noise rise can be synthetically generated.

A computer program comprising program code means adapted to perform any necessary steps, when the program is run on a processor can implement the invention and its embodiments. These steps can comprise e.g. receiving a signal; filtering the signal with a matched filter; detecting an impulse response from the filtered signal; applying parameters from the detected impulse response to a reconstruction equation; reconstructing the received signal according to the reconstruction equation; and subtracting the reconstructed signal from the input signal for obtaining a first residual signal.

It also is possible to have a computer program product comprising program code means stored in a computer readable medium, the program code means being adapted to perform any of said steps, when the program is run on a computer or on a processor.

All modifications and configurations required for implementing functionality of the embodiments may be performed as routines, which may be implemented as added or updated software routines, application circuits ASIC and/or programmable circuits. Software routines, also called program products, including applets and macros, can be stored in any apparatus-readable data storage medium and they include program instructions to perform particular tasks. Software routines may be downloaded into an apparatus. The apparatus, such as controllers, or corresponding server components, or a user terminal may be configured as a computer including at least a memory for providing storage area used for arithmetic operation and an operation processor for executing the arithmetic operation. An example of the operation processor includes a central processing unit. The memory may be removable memory detachably connected to the apparatus.

The invention and its embodiments provide as effective measurement and emulation system as possible. One possibility is to apply a Serial Interference Cancellation method into the signal and interference processing. It is also possible to formulate the signal from the impulse response and replay the interference as the residual signal. One possibility is to combine the serial interference cancellation method with the method of replaying the residual signal.

This invention can be applied in many different test environments, e.g. in a so-called virtual drive test environment. This means that in virtual drive test the field tests are done in a laboratory as accurately as possible The interference may be simulated with less HW resources than in case of the replaying the residual signal.

The invention and its embodiments provide many advantages. E.g. the interference profile may now be based on the measurements and not on the guess such as in prior art synthetic cases, enabling the full realism. Furthermore, the complexity of test setup becomes less critical than in direct playback modes. An advantage of the method and arrangement of the invention is simpler structure and fast and accurate functioning of the emulator. This also makes the quality of communication better. Now the interference may also be repeatable and correct. Less hardware resources is also needed than in conventional solutions.

It will be obvious to a person skilled in the art that, as the technology advances, the inventive concept can be implemented in various ways. The invention and its embodiments are not limited to the examples described above but may vary within the scope of the claims.

What is claimed is:

1. A method for extracting a signal and an interference from communication measurements, comprising;
receiving and storing a communication comprising the signal and the interference;
feeding the received communication through a filter for detecting an impulse response peak in the filtered signal or in the filtered interference and to achieve the impulse response peak as an output from the filter;
feeding the output from the filter to a regenerator for reconstructing the received signal component or the interference component according to the reconstruction equation; and
feeding the output from the regenerator to a subtractor for obtaining a residual signal component or the residual interference component from the communication;
feeding the obtained residual signal again through the same filter, the same regenerator, and same the subtractor for obtaining the next residual signal or interference components from the communication until the whole signal or whole interference is reconstructed with appropriate signal components.

2. (canceled)

3. A method according to claim 1, comprising obtaining the residual signal components or the residual interference components from the received communication in series or in parallel.

4. A method according to claim 1, comprising obtaining further residual signal components and/or further residual interference components by means of the same filter, regenerator and subtractor.

5. A method according to claim 1, wherein the reconstructed input signal fulfills the following equation:
$$s ( t , τ ) = {\sum }_{i = 1}^{N} {A}_{i} {e}^{j 2 π υ t} u ( t - τ )$$
wherein Aᵢ refers to the amplitude of the signal, exp refers to the phase of the signal and u refers to the transmitted signal form, and wherein the parameters tau and nu are taken from the measured data, and wherein N indicates how far the index i runs.

6. A method according to claim 1, wherein the reconstructed interference signal fulfills the following equation:
$$i ( t , τ ) = {\sum }_{i = 1}^{N} {A}_{i}^{′} {e}^{j 2 π {υ}^{′} t} {u}^{′} ( t - {τ}^{′} )$$
where Aᵢ′ refers to the amplitude of the interference signal, exp′ to the phase of the interference signal and u′ refers to the form of the transmitted interference signal, and wherein the parameters tau′ and nu′ are taken from the measured data, and wherein N indicates how far the index i runs.

7. A device for extracting a signal and interference from communication measurements, the device being configured to:
receive a communication comprising a signal and an interference;
feed the received communication through a filter, a regenerator, and a subtractor for obtaining residual signal components from the communication;
store the received communication signal; and
feed the received communication signal again through the same filter, the same regenerator, and same the subtractor for obtaining residual interference components from the communication.

8. A computer-readable medium comprising instructions encoded thereon that, when executed by a computing device, cause the computing device to:
receive and store a communication comprising the signal and the interference;
feed the received communication through a filter for detecting an impulse response peak in the filtered signal or in the filtered interference and to achieve the impulse response peak as an output from the filter;
feed the output from the filter to a regenerator for reconstructing the received signal component or the interference component according to the reconstruction equation;
feed the output from the regenerator to a subtractor for obtaining a residual signal component or the residual interference component from the communication; and
feed the obtained residual signal again through the same filter, the same regenerator, and same the subtractor for obtaining the next residual signal or interference components from the communication until the whole signal or whole interference is reconstructed with appropriate signal components.

9. A computer-readable medium according to claim 8, comprising instructions encoded thereon that, when executed by the computing device, cause the computing device to obtain the residual signal components or the residual interference components from the received communication in series or in parallel.

10. A computer-readable medium according to claim 8, comprising instructions encoded thereon that, when executed by the computing device, cause the computing device to obtain further residual signal components and/or further residual interference components by means of the same filter, regenerator and subtractor.

11. A computer-readable medium according to claim 8, wherein the reconstructed input signal fulfills the following equation:
$$s ( t , τ ) = {\sum }_{i = 1}^{N} {A}_{i} {e}^{j 2 π υ t} u ( t - τ )$$
wherein Aᵢ refers to the amplitude of the signal, exp refers to the phase of the signal and u refers to the transmitted signal form, and wherein the parameters tau and nu are taken from the measured data, and wherein N indicates how far the index i runs.

12. A computer-readable medium according to claim 8, wherein the reconstructed interference signal fulfills the following equation:
$$i ( t , τ ) = {\sum }_{i = 1}^{N} {A}_{i}^{′} {e}^{j 2 π {υ}^{′} t} {u}^{′} ( t - {τ}^{′} )$$
where Aᵢ′ refers to the amplitude of the interference signal, exp′ to the phase of the interference signal and u′ refers to the form of the transmitted interference signal, and wherein the parameters tau′ and nu′ are taken from the measured data, and wherein N indicates how far the index i runs.
